(19) United States
(12) Patent Application Publication
(10) Pub. No.: US 2007/0108679 A1
(43) Pub. Date: May 17, 2007

(54) Spring core

(75) Inventor: Wolfgang Grothaus, Bad Essen (DE)

Correspondence Address: BARNES & THORNBURG LLP, 750-17TH STREET NW, SUITE 900, WASHINGTON, DC, 20006-4675, US

(73) Assignee: AGRO Federkernproduktions GmbH

(21) Appl. No.: 11/600,170

(22) Filed: Nov. 16, 2006

(30) Foreign Application Priority Data
Nov. 17, 2005 (DE) 102005054725.7-16

(51) Int. Cl. F16F 1/18

(52) U.S. Cl. 267/158

(57) ABSTRACT

A spring core includes a plurality of individual springs. Each individual spring includes at least one spring band configured to be deformed to have a bulge and shaped to form at least a partial ring in a loading plane.

### BACKGROUND AND SUMMARY CROSS-REFERENCE

This application claims priority to German Application 10 2005 054 725.7 filed Nov. 17, 2005, which disclosure is hereby incorporated herein by reference.

### BACKGROUND AND SUMMARY

The present disclosure relates to a spring core including a plurality of individual springs.

Such spring cores are used in different fields. As an example, spring cores are used for upholstered furniture, particularly for mattresses.

The individual springs of the known spring cores are constructed as helical springs and normally consist of metal.

However, the known spring cores have a number of disadvantages. Thus, the relatively high weight of the spring cores equipped with metal springs has multiple unfavorable effects. For example, as a result of the high weight, the transport costs from the manufacturer of the spring cores to the further processing company are relatively high, which naturally stands in the way of an optimized cost structure.

Another disadvantageous criterion is the electrical conductivity of the helical springs consisting of metal which often does not meet the health-conscious wishes of the users of such spring cores or mattresses made of such spring cores. In particular, the forming magnetic fields, also so-called Earth radiation, which can be influenced by metal, cause a health-conscious consumer to have reservations which should be taken seriously.

In order to take this circumstance into account, it has been attempted to produce the helical springs of plastic material. However, this can be achieved only at considerable manufacturing-related expenditures. That is because the starting product, specifically plastic wire, has to be heated to generate the coiling in order to achieve the helical shape.

An economical production which is optimized from a manufacturing-related point of view, as it is endeavored for such a serial product like the spring core, cannot be achieved by such a solution.

Thus, the present disclosure relates to a spring core such that, while the usage comfort is unchanged, has a usability that is more cost-effective with respect to manufacturing.

The present disclosure includes a spring core comprising a plurality of individual springs. Each individual spring includes at least one spring band configured to be deformed to have a bulge and shaped to form at least a partial ring in a loading plane.

A spring core, as just described, is characterized by low weight, which is advantageous with respect to the handling and the transport of the spring core.

However, also with respect to the achievable comfort of use, significant improvements are made compared to the known state of the art. Thus, the individual springs are distinguished, for example, by a high point elasticity.

A configuration of the spring core of the present disclosure as a multi-purpose spring core can be achieved at low expenditures. Thus, a wall thickness of the spring band, the spring shape and the number of springs can be varied.

With respect to the spring shape, it is conceivable to provide a dimension of the bulging differently, or the springing action as a result of the number of spring bands of an individual spring.

The spring band may include metal, such as spring band sheet metal, which, however, does not have the characteristics with respect to non-existing electrical conductivity or non-existing magnetic fields.

In order to keep the spring core free of these physical conditions, the individual spring or the spring band may be made of a plastic material, such as a composite fiber material. Composite fiber materials made of polypropylene in combination with fibers, such as glass fibers, or the like, as well as KEVLAR®, generic name poly-para-phenylene terephthalamide, are suitable for this purpose. Furthermore, this material can be completely recycled, which is of considerable environmental significance.

Individual fibers can be combined to form a spring core, for example, by a nonwoven covering, the two broad sides each having a nonwoven covering. In this case, a strip-type slitting in the respective nonwoven covering contributes to an optimization of the stability of the spring core, by which slitting, such as by diagonal strips, are formed. For a lateral hold, borders of nonwoven material are provided. The nonwoven coverings are, for example, glued together with the individual springs, so that an inherent stability is ensured.

In addition, the nonwoven covering can be constructed as a grid. Furthermore, crosstie rods are provided. The crosstie rods include, for example, an elastic material, for a longitudinal fixing of the spring core.

It is advantageous to keep the spring band, which is bent to form at least a partial ring, prestressed by a tension thread, which is guided through the two mutually opposite spring band regions and has a correspondingly short formation.

An embodiment of an individual spring includes two spring bands connected with one another in a mutually crossing manner by the tension thread. Thus, if each spring band including a fully circumferential ring, ball-type springs are formed which, in a loading direction, represent four individual partial springs and four point-elastic elements. The ball-type spring is compressed during the loading corresponding to the applied force. Points of application of reaction forces move along the crossed rings toward an outside in a direction of the equator.

The individual springs are modified in their corner regions of the spring core and the sides. In such a case, a corner spring includes two spring bands, which each have a bulging to only one side and thus form a partial ring in a sense of half an ellipse and are both arranged at a 90° angle with respect to one another.

A lateral individual spring is constructed as a border spring by half a partial ring and a fully circumferential ring, the latter forming the lateral end and being aligned with the fully circumferential ring of the adjacent individual spring, while the partial ring projects into an interior of the spring core.

Other aspects of the present disclosure will become apparent from the following descriptions when considered in conjunction with the accompanying drawings.

### BRIEF DESCRIPTION OF THE DRAWINGS

FIG. 1 is a perspective view of an individual spring of a spring core, according to the present disclosure.

FIG. 2 is a lateral view of the individual spring of FIG. 1 in different loading positions.

FIG. 3 is a top view of a partial cutout of an embodiment of a spring core, according to the present disclosure.

FIG. 4 is a top view of a partial cutout of another embodiment of a spring core, according to the present disclosure.

### DETAILED DESCRIPTION

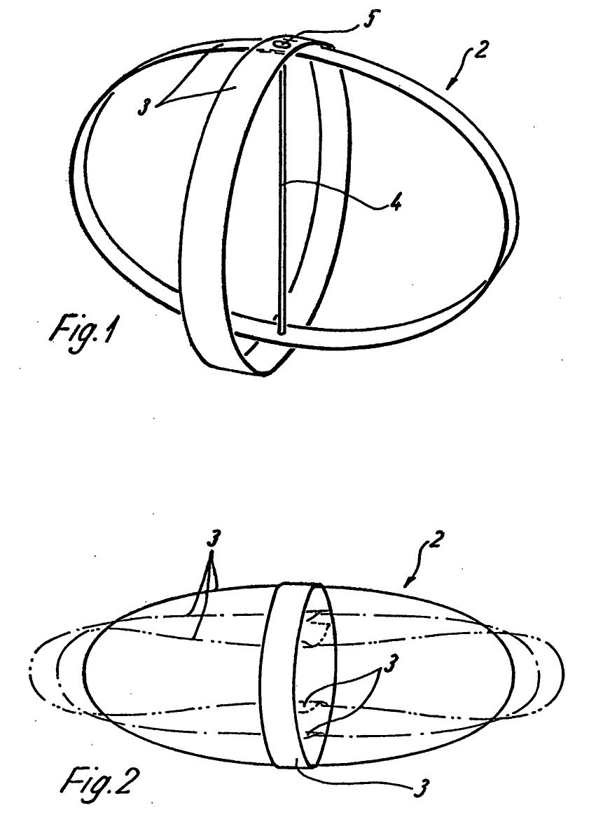

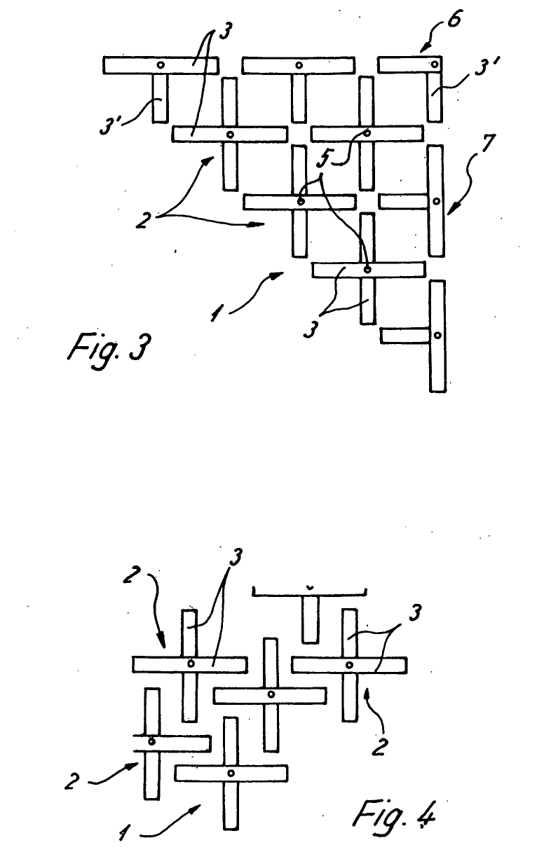

Embodiments of a spring core 1 are shown in FIGS. 3 and 4 as partial cutouts. Spring cores 1 include a plurality of individual springs 2 which are each formed of at least one spring band 3 deformable in a bulge-type fashion when loaded. Individual springs 2 are shaped in a loading plane to form at least a partial ring, as shown in FIGS. 1 and 2. The solid lines in FIG. 2 indicate an unloaded position of the individual spring 2, while different loading positions are illustrated by dash-dotted lines in FIG. 3, in which the individual springs 2 are compressed to a corresponding degree.

An outer border of the spring core 1 is bounded by border springs 7 (see FIG. 3) as well as by a corner spring 6 at each corner. Border spring 7 includes a fully circumferential spring band 3, which forms a closed ring. Also included is a half a ring 3′, which extends in an interior direction of the spring core 1, while the spring band 3 formed as a closed ring forms an outer edge.

The corner spring 6 is formed of two half rings 3′ disposed at a right angle with respect to one another. Each individual interior spring 2 has two spring bands 3 which are arranged in a manner of meridians and cross one another at a right angle.

In a top side and bottom side crossing region, the spring bands 3 are held by one holding head 5, respectively, which bounds an end of a thread 4 whose length is such that the two spring bands 3 are prestressed and describe an elliptical shape in the process.

In contrast, in an opposite direction or in a mutually facing direction, the spring bands 3 are. freely movable. That is, each individual spring 2 can be compressed depending on the loading, as illustrated in FIG. 2.

Such movability also exists in the case of the lateral or border springs 7 and the corner springs 6.

The arrangement of the individual springs 2 with respect to one another can take place corresponding to the pattern shown in FIG. 3, in which each individual spring 2 is arranged at a narrow distance from the adjacent individual spring 2. Or, the pattern can be by an interlaced arrangement with respect to one another, corresponding to the representation shown in FIG. 4.

Although the present disclosure has been described and illustrated in detail, it is to be clearly understood that this is done by way of illustration and example only and is not to be taken by way of limitation. The scope of the present disclosure is to be limited only by the terms of the appended claims.

1. Spring core consisting of a plurality of individual springs (2), characterized in that each individual spring (2) consists of at least one spring band (3) which can be deformed in a bulging fashion and is shaped to form at least a partial ring in the loading plane.

2. Spring core according to claim 1, characterized in that the spring band (3) is made of a composite fiber material.

3. Spring core according to claim 1 or 2, characterized in that the spring band is formed of polypropylene and glass fibers.

4. Spring core according to one of the preceding claims, characterized in that the spring band (3) consists of Keflar.

5. Spring core according to one of the preceding claims, characterized in that each individual spring (2) consists of at least two spring bands (3) which are arranged in the manner of meridians and are jointly held in the crossing region.

6. Spring core according to one of the preceding claims, characterized in that a corner spring (6) is arranged in each corner area, which corner springs (6) consist of two spring bands each forming a half ring (3′).

7. Spring core according to one of the preceding claims, characterized in that a plurality of border springs (7) are arranged in the border area, which border springs (7) consist of a spring band (3) forming a complete ring and of a spring band constructed as a half ring (3′) connected thereto.

8. Spring core according to one of the preceding claims, characterized in that the individual springs (2) are positioned in an interlaced manner with respect to one another.

9. Spring core according to one of the preceding claims, characterized in that the spring bands (3, 3′) of each individual spring (2) or border spring (7) and corner spring (6) are prestressed.

10. Spring core according to one of the preceding claims, characterized in that, for achieving the prestressing, a tension thread (4) is provided which is held in the crossing region of the spring bands (3, 3′) and prestresses the spring bands (3, 3′).

11. Spring core according to one of the preceding claims, which has several zones of a different spring action, characterized in that the spring bands (3, 3′) of the individual springs (2, 6, 7) are constructed with different wall thicknesses.

12. Spring core according to one of the preceding claims, characterized in that the individual springs (2, 6, 7) are mutually connected by means of at least one covering, preferably a nonwoven covering.

13. Spring core according to one of the preceding claims, characterized in that the covering has a plurality of strips, preferably diagonally aligned strips.

14. Spring core according to one of the preceding claims, characterized in that the covering is constructed in the form of a grid.
